(19) United States
(12) Patent Application Publication
(10) Pub. No.: US 2025/0322459 A1
(43) Pub. Date: Oct. 16, 2025

(54) Heppner Silk AltQuote™ - Online Computer-Implemented Integrated System for Providing Alternative Asset Peer-Group Based Valuations

(71) Applicants: Brad K. Heppner, Dallas, TX (US); The Beneficient Company Group (USA), L.L.C., Dallas, TX (US)

(72) Inventors: Brad K. Heppner, Dallas, TX (US); Sam Hikspoors, Austin, TX (US)

(21) Appl. No.: 18/958,020

(22) Filed: Nov. 25, 2024

Related U.S. Application Data
(63) Continuation of application No. 17/972,147, filed on Oct. 24, 2022, now abandoned.
(60) Provisional application No. 63/324,250, filed on Mar. 28, 2022.

(51) Int. Cl. G06Q 40/06

(52) U.S. Cl. CPC G06Q 40/06

(57) ABSTRACT

Disclosed is a real-time online public access computer implemented system for calculating algorithms for valuing an alternative asset based on correlative technical performance indicators of relative peer assets.

### CROSS-REFERENCE TO RELATED APPLICATIONS

The present application is a continuation of U.S. patent application Ser. No. 17/972,147, filed Oct. 24, 2022, which claims the benefit of and priority to U.S. Provisional Application No. 63/324,250, filed Mar. 28, 2022. Each of the foregoing applications is hereby incorporated by reference herein in its entirety.

### TECHNICAL FIELD

The present disclosure relates to alternative assets, and more particularly, to systems and methods for evaluating, diversifying, and/or monitoring Alternative Asset Products which serve as Reference Assets backing Financings.

### BACKGROUND

Certain assets have robust markets that provide liquidity in exchange of such assets. Equity and debt securities, commodity contracts, and derivatives of those instruments, are examples of liquid assets that often have robust markets. Readily available liquidity to exchange assets provides an efficient mechanism to realize appreciation in asset values and to manage losses in asset values.

While certain asset classes have sufficient liquidity supported through robust markets, other asset classes do not. For example, artwork is an example of an asset with long transactional horizons, valuation challenges, and inefficient markets. The lack of a robust market for such asset types results in risk management difficulties. There is interest in providing improved risk management capabilities for certain asset classes which do not have robust markets and are generally considered to be illiquid.

### SUMMARY

The present disclosure relates to systems and methods for evaluating, diversifying, and/or monitoring Alternative Asset Products which serve as Reference Assets backing Financings. As used herein, the term “Alternative Asset Products” refers to and includes interest(s), or derivatives thereof, in an alternative asset through a Fund or other alternative asset investment vehicle, as applicable, or special purpose vehicle holding interest(s) in any of the foregoing. As used herein, the term “Fund” refers to and includes private professionally managed alternative asset investment funds. In various embodiments, the present disclosure relates to a Financing backed by an Alternative Asset Product. As used herein, the term “Financing” shall mean and include any structure or process of providing capital in exchange for a specific agreed-upon return, and/or insurance products providing a specific agreed-upon insurance coverage. For example, a Financing may be in the form of debt or equity instruments or an insurance policy. As used herein, the term “Default” shall mean and include any occurrence or circumstance by which a specific agreed-upon expected return or specific agreed-upon insurance coverage is not satisfied according to the terms of the Financing.

The present disclosure may refer to Alternative Asset Products or interests in Alternative Asset Products when used to back a Financing as a “Reference Asset.” In aspects, the present disclosure provides systems and methods which forecast expected returns and cashflow distributions for Alternative Asset Products. In aspects, the present disclosure provides systems and methods which diversify a portfolio of Alternative Asset Products which serve as Reference Assets for one or more Financings. In aspects, the present disclosure provides systems and methods which monitor the concentration of a portfolio of Alternative Asset Products. The various aspects can be combined in various ways to evaluate, diversify, and/or monitor Alternative Asset Products which serve as Reference Assets for a Financing.

Various terms above and below may be capitalized to indicate an identification. Unless otherwise indicated, such capitalization is not intended to limit the capitalized term to a particular definition or meaning.

Aspects of the present disclosure may be referred to herein as “AltQuote.”

In accordance with aspects of the present disclosure, a computer-implemented method includes: accessing information relating to an Alternative Asset Product received through an online portal; computing an expected return for the Alternative Asset Product; forecasting cashflow dispersion for the Alternative Asset Product based on a quantitative stochastic model and simulation; determining Financing parameters for a proposed Financing based on the expected return and the forecasted cashflow dispersion for the Alternative Asset Product and based on the Alternative Asset Product serving as a Reference Asset for the proposed Financing; and presenting the Financing parameters through the online portal as a real-time quote.

In various embodiments of the computer-implemented method, the Financing parameters are determined based on a predetermined Financing structure.

In various embodiments of the computer-implemented method, the method includes receiving a desired Financing structure via the online portal, and the Financing parameters are determined based on the desired Financing structure.

In various embodiments of the computer-implemented method, the Financing parameters include a Financing level based on the Alternative Asset Product serving as a Reference Asset for the proposed Financing and based on a predetermined Default rate.

In accordance with aspects of the present disclosure, a system includes: one or more processors, and at least one memory storing instructions. The instructions, when executed by the one or more processors, cause the system to: access information relating to an Alternative Asset Product received through an online portal; compute an expected return for the Alternative Asset Product; forecast cashflow dispersion for the Alternative Asset Product based on a quantitative stochastic model and simulation; determine Financing parameters for a proposed Financing based on the expected return and the forecasted cashflow dispersion for the Alternative Asset Product and based on the Alternative Asset Product serving as a Reference Asset for the proposed Financing; and present the Financing parameters through the online portal as a real-time quote.

In various embodiments of the system, the Financing parameters are determined based on a predetermined Financing structure.

In various embodiments of the system, the instructions, when executed by the one or more processors, further cause the system to receive a desired Financing structure via the online portal, and the Financing parameters are determined based on the desired Financing structure.

In various embodiments of the system, the Financing parameters include a Financing level based on the Alternative Asset Product serving as a Reference Asset for the proposed Financing and based on a predetermined Default rate.

Further details and aspects of exemplary embodiments of the present disclosure are described in more detail below with reference to the appended figures.

### BRIEF DESCRIPTION OF THE DRAWINGS

FIG. 1 is a block diagram of an exemplary transaction between a financier and a recipient, in accordance with aspects of the present disclosure;

FIG. 2 is a block diagram of exemplary portfolio of Financings which are backed by a portfolio of Alternative Asset Products, in accordance with aspects of the present disclosure;

FIG. 3 is a block diagram of an exemplary operation for evaluating, diversifying, and/or monitoring alternative and/or illiquid asset Funds which serve as Reference Assets for a Financing, in accordance with aspects of the present disclosure;

FIG. 4 is a flow diagram of an exemplary operation for forecasting expected returns and cashflow distributions for an Alternative Asset Product, in accordance with aspects of the present disclosure;

FIG. 5 is a diagram of an exemplary lifecycle for an Alternative Asset Product, in accordance with aspects of the present disclosure;

FIG. 6 is a flow diagram of an exemplary operation for determining target alternative asset allocation for a portfolio of Alternative Asset Products, in accordance with aspects of the present disclosure;

FIG. 7 is a diagram of an exemplary J-Curve effect for a buyout Fund, in accordance with aspects of the present disclosure;

FIG. 8 is a flow diagram of an exemplary operation for determining a portfolio concentration score for a portfolio of Alternative Asset Products, in accordance with aspects of the present disclosure;

FIG. 9 is a diagram of an exemplary operation for providing a quote to a holder of interests in an Alternative Asset Product, in accordance with aspects of the present disclosure;

FIG. 10 is a flow diagram of an exemplary operation for determining Financing parameters, in accordance with aspects of the present disclosure; and

FIG. 11 is a diagram of an exemplary computing system.

### DETAILED DESCRIPTION

The present disclosure relates to systems and methods for evaluating, diversifying, and/or monitoring Alternative Asset Products which serve as Reference Assets backing Financings. Unless otherwise specified or otherwise indicated by the context, the term “alternative asset” is used herein to mean and include any type of asset that does not have a market by which a holder-of-interests can exchange its interests in the asset for financial remuneration at a time desired by the holder-of-interests. The term “illiquid asset” may be used interchangeably with “alternative asset.” Examples of alternative assets include, without limitation, interests in private equity, venture capital, leveraged buyout, structured credit, private debt, real estate, feeder funds, fund of funds, life insurance policies, natural resources, non-traded business development company, and/or non-traded real-estate investment trusts, and/or other intangible assets, among other things. Unless noted otherwise, the singular and plural forms of “alternative asset” and of “illiquid asset” will be used interchangeably herein, such that any disclosure relating to “alternative asset” is applicable to “alternative assets” as well, and vice versa.

As mentioned above, the term “Alternative Asset Products” refers to and includes interest(s), or derivatives thereof, in an alternative asset through a Fund or other alternative asset investment vehicle, as applicable, or special purpose vehicle holding interest(s) in any of the foregoing. As mentioned above, the term “Fund” refers to and includes private professionally managed alternative asset investment funds. In various embodiments, the present disclosure relates to a Financing backed by an Alternative Asset Product.

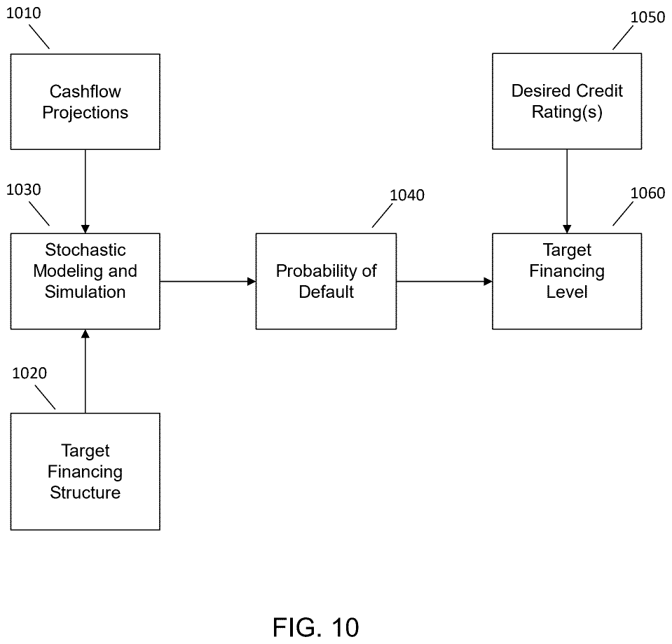

Systems and methods are described below in connection with various figures. The description and figures are intended to be examples of systems and methods according to the present disclosure, and it will be understood that such examples do not limit the scope of the present disclosure. The drawings and description below relate to various operations. Although various operations are presented in a particular sequence, such operations or portions of operations can be implemented in a different sequence than as described or illustrated herein. Additionally, various operations or portions of operations can be implemented concurrently or simultaneously. Portions of one or more operations can be implemented in one or more other operations and/or can be implemented differently than as illustrated or described. The illustrations and descriptions herein may describe operations involving an Alternative Asset Product. It is contemplated that such disclosure can be applied sequentially, concurrently, or simultaneously to more than one Alternative Asset Product. The operations described herein can be implemented by a computing system, which will be described in connection with FIG. 10.

Various terms below may be capitalized to indicate an identification. Unless otherwise indicated, such capitalization is not intended to limit the capitalized term to a particular definition or meaning. In connection with the description below, the following terms have the following meanings.

The term “asset” means and includes anything of value, including any property, whether it is real, personal, fixed, intangible, monetary, or otherwise.

The term “interest” means and includes any legal right in or to an asset.

The term “beneficial interest” means and includes the interests that a beneficiary of a special purpose vehicle (e.g., a trust) has with respect to its interest in such special purpose vehicle.

In the description herein, the terms “asset” and “interest” in an asset may be used interchangeably, such that any description herein relating to an asset shall be applicable any interest in the asset, and any description relating to an interest in an asset shall be applicable to the asset as well. Additionally, description herein relating to an asset or an interest in an asset shall be applicable to an Alternative Asset Product which holds assets or holds interests in assets, and description herein relating to an Alternative Asset Product which holds assets or holds interests in assets shall be applicable to an asset or an interest in an asset.

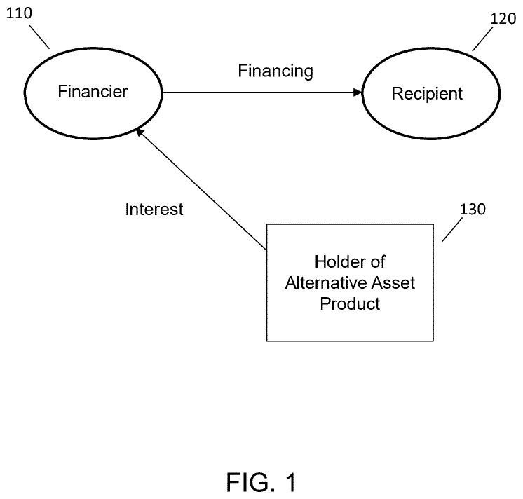

Referring to FIG. 1, there is shown an exemplary transaction between a financier 110 which provides a Financing and a recipient 120 which receives the Financing. Additionally, the exemplary transaction involves a holder 130 of an Alternative Asset Product, which may be the same entity as the recipient 120 or may be a separate entity. For example, in various embodiments, the recipient 120 and the holder 130 may be separate trusts. In various embodiments, the recipient 120 may be a trust and the holder 130 may be a partnership. Other types of entities are contemplated for the recipient 120 and the holder 130. The holder 130 conveys an interest to the financier 110 such that the Alternative Asset Product serves as Reference Asset for the Financing.

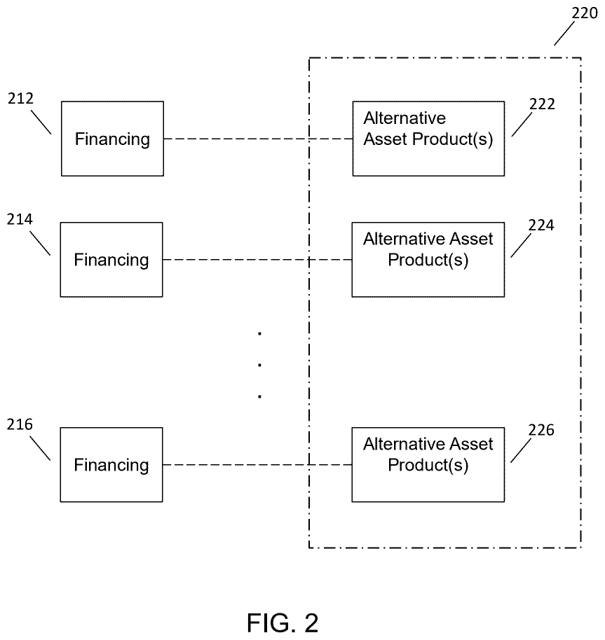

FIG. 2 shows a diagram of multiple Financings originated by one or more financiers where the Financings are backed by Alternative Asset Products. In the illustrated embodiment, the multiple Financings 212-216, such as a number N of Financings, are each backed by or based on one or more Alternative Asset Products 222-226. The Reference Assets 222-226 collectively form a portfolio 220 of Alternative Asset Products. Each of the Reference Asset 222-226 may have undesirable risk characteristics on a stand-alone basis and concentrated basis, but a portfolio 220 of Alternative Asset Products can be diversified to manage such risks.

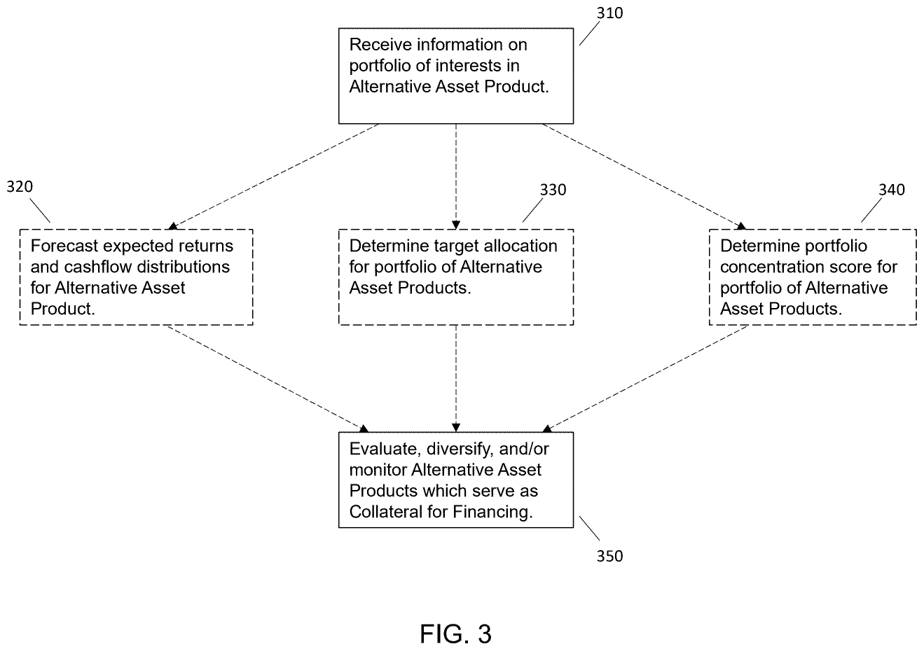

FIG. 3 shows a block diagram of an exemplary operation for evaluating, diversifying, and/or monitoring Alternative Asset Products which serve as Reference Assets for one or more Financings. Some or all of the operations in FIG. 3 may be implemented by a computing system, which will be described later herein in connection with FIG. 10. FIG. 3 includes dashed lines to indicate that the dashed operations may be implemented individually or may be implemented in various combinations.

At block 310, the operation involves receiving information on a portfolio of Alternative Asset Products. The information may be received from various information sources, such as local databases, third party databases, public data sources, sources of current price quotes for various financial instruments, and/or databases of historical financial information, among other sources. The information can include information specific to a particular alternative asset type, public equity information, and economic information, which will be described in more detail later herein.

In various embodiments, the information can include whether an alternative asset underlying the Alternative Asset Product belongs to a risk dimension. The term “risk dimension” refers to an allocation dimension (e.g., region, section, etc.) which presents concentration risks when over-allocated. In various embodiments, the risk dimensions for computing the concentration score can be, for example, Alternative Asset Product type/class, sector, geography, specific fund risk, or specific investment risk. In various embodiments, the types/classes of alternative assets include private equity, venture capital, private debt, private real estate, natural resource funds, and infrastructure funds. Examples of these asset types are shown in the table below.

| | |
|---|---|
| Private Equity | Refers to and includes buyouts and growth funds, which |
| | mainly invests in relatively mature companies. |
| Venture Capital | Refers to and includes earlier stages of equity |
| | investments in young companies. |
| Private Debt | Refers to and includes mezzanine and distressed debt |
| | investments. |
| Private Real | Refers to and includes all private fund investment |
| Estate | vehicles in broad real estate markets. |
| Natural | Refers to and includes private fund investments across |
| Resource | real assets in markets such as energy, metals, timber, |
| Funds | and agriculture. |
| Infrastructure | Refers to and includes investments in crucial |
| Funds | infrastructure development projects such as toll roads, |
| | airports, electric and water utility services. |
| Hedge Funds | Refers to and includes investments in all hedge fund |
| | types, across asset classes and investment strategies. |

The examples in the table above are merely illustrative, and variations are contemplated to be within the scope of the present disclosure. For example, in various embodiments, the types/classes of Alternative Asset Products may be more granular and can include private equity, venture capital, leveraged buyout, structured credit, private debt, real estate, feeder funds, fund of funds, life insurance policies, natural resources, non-traded business development company, and/or non-traded real-estate investment trusts. Other types/classes of Alternative Asset Products are contemplated to be within the scope of the present disclosure. The information described above is exemplary, and other information relating to Alternative Asset Products may be received at block 310. All such other information are contemplated to be within the scope of the present disclosure.

Referring to blocks 320-340, and as mentioned above, the blocks may be implemented individually or in various combinations. Specifically, only one of the three blocks may be implemented, or two of the three blocks may be implemented, or all three blocks may be implemented. Each block is described below.

At block 320, the operation forecasts expected returns and cashflow distributions for an Alternative Asset Product. In various embodiments, block 320 may be implemented solely to evaluate the expected return and distributions of an Alternative Asset Product, such as one of the Alternative Asset Products 222-226 of FIG. 2. In various embodiments, block 320 may be implemented to evaluate the expected returns and distributions of an Alternative Asset Product that is that is proposed as a Reference Asset for a new Financing, or to evaluate the returns and distributions of an Alternative Asset Product that is already a Reference Asset for an existing Financing. Other uses are contemplated for applying block 320, and all such uses are contemplated to be within the scope of the present disclosure. Various aspects of implementing block 320 will be described in more detail below.

At block 330, the operation determines a target allocation for a portfolio of Alternative Asset Products. As mentioned above, an Alternative Asset Product may have undesirable risk characteristics on a stand-alone basis and concentrated basis, but a portfolio of Alternative Asset Products can be diversified to manage such risks. Various aspects of implementing block 330 will be described in more detail below. The target allocation provided by block 330 can be used to guide which risk dimensions of Alternative Asset Products should be targeted as new Reference Assets for new Financings, to structure the terms of a new Financing based on a risk dimension of Alternative Asset Product, and/or to monitor an existing portfolio of Alternative Asset Products, such as the portfolio 220 of FIG. 2.

At block 340, the operation determines portfolio concentration score for a portfolio of Alternative Asset Products. In various embodiments, the operation can determine the level (e.g., in percentage terms) of portfolio over-allocation in any risk dimension, such as Alternative Asset Product type/class, sector, geography, and/or specific fund or specific investment risks. In various embodiments, the operations of block 340 can be used to evaluate the concentration of Alternative Asset Products in an existing portfolio. In various embodiments, the operations of block 340 can be used to evaluate the concentration of Alternative Asset Products in a proposed portfolio or in a portfolio to which new Alternative Asset Products may be added. Various aspects of implementing block 340 will be described in more detail below.

At block 350, the operation can evaluate, diversify, and/or monitor Alternative Asset Products which serve as Reference Assets for Financings, based on the results of one or more of blocks 320-340. In various embodiments, the operation of block 350 can display and/or use forecasts of expected returns and cashflow distributions for an Alternative Asset Product, which are determined at block 320. In various embodiments, the operation of block 350 can display and/or use a target allocation for a portfolio of Alternative Asset Products, which is determined at block 330. In various embodiments, the operation of block 350 can display and/or use the concentration of Alternative Asset Products in a portfolio, which is determined at block 340. The operation of block 350 can use the results of blocks 320-340 to evaluate a new Alternative Asset Product or a new portfolio that is proposed, or to evaluate, diversify, and/or monitor existing Alternative Asset Products or an existing portfolio, or to evaluate existing and new Alternative Asset Products or a portfolio of existing and new Alternative Asset Products.

The illustrated embodiment of FIG. 3 is exemplary, and variations are contemplated to be within the scope of the present disclosure. For example, evaluating, diversifying, and/or monitoring Alternative Asset Products or a portfolio of Alternative Asset Products may involve other operations not shown in FIG. 3, and such operations are contemplated to be within the scope of the present disclosure.

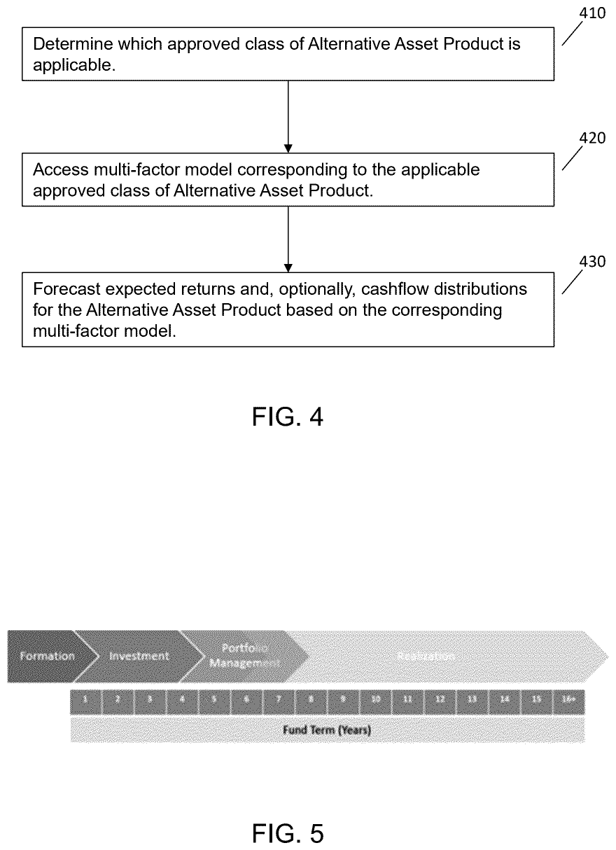

Referring now to FIG. 4, there is shown a block diagram of an exemplary operation for forecasting expected returns, and optionally cashflow distributions, for an Alternative Asset Product. As mentioned above in connection with block 320 of FIG. 3, the illustrated operation may be used solely to forecast expected returns (and optionally distributions) of an Alternative Asset Product, or may be used to forecast expected returns (and optionally distributions) of an Alternative Asset Product that is proposed as a Reference Asset for a new Financing, or may be used to forecast expected returns (and optionally distributions) of an Alternative Asset Product that is already a Reference Asset for an existing Financing, among other uses. The operations of FIG. 4 can be implemented by a computing system, which will be described later herein in connection with FIG. 10.

At block 410, the operation involves determining which approve type/class of Alternative Asset Products is applicable to an Alternative Asset Product. The approved types/classes of Alternative Asset Products can include, for example, private equity, venture capital, private debt, private real estate, natural resource funds, and infrastructure funds, as mentioned above, or other types/classes of alternative assets.

At block 420, the operation involves accessing a multi-factor model corresponding to the approved class of Alternative Asset Products that is applicable to the Alternative Asset Product being evaluated. In accordance with aspects of the present disclosure, each approved type/class of Alternative Asset Products has a corresponding multi-factor model which is used to forecast expected returns and, optionally, cashflow distributions for Alternative Asset Products of that type/class. A “baseline” version of the multi-factor model is calibrated based on historical data to provide forecasts which reflect long-run historical averages over at least one full market-cycle. A “forward-adjusted” version of the multi-factor model adjusts the baseline version based on various forward-looking economic and market indicators to improve forecasts. Generally, both the baseline and the forward-adjusted multi-factor models consider returns of an Alternative Asset Product as having a private return component and public return components, which are described below.

For the baseline model, the private return component and the public return component are calibrated to historical data for the applicable type of alternative asset. With respect to the public return components, the return of an Alternative Asset Product may be influenced to some degree by one or more public market indexes which affect the performance of the Alternative Asset Product. Shown below are examples of various public market indices which may influence various approved types/classes of Alternative Asset Products. The public return component of the baseline model for an alternative asset can be calibrated to the historical data of the corresponding public market index/indices.

| Type of Asset | Public Market Index/Indices |
|---|---|
| Buyouts | Broad Equities |
| Growth Capital | Broad Equities |
| Venture Capital | Tech sector & Broad Equities |
| Private Debt | High Yield Corporate Bonds & Broad |
| | Equities |
| Private Real Estate | REITs & Broad Equities |
| Natural Resources | Energy Sector & GSCI |
| Infrastructure | GDP Index |

With respect to the private return component of the baseline model, the private return component for an Alternative Asset Product can be calibrated to the historical data of various drivers or signals relating to the historical outperformance of the type/class of Alternative Asset Product. The drivers or signals can include, but are not limited to, those listed below, which can be identified based on fundamental analysis and/or statistical data analysis. Where a listed driver/signal refers to a “fund,” the Alternative Asset Product is interest(s) in a fund. Where a listed driver/signal refers to a partnership, the Alternative Asset Product is managed by a partnership.

### Exemplary Drivers or Signals for Private Return Component

Increase in total size from the last fund
Level of institutional limited partnership (LP) retention
General partnership (GP) succession plan
GP ongoing fundraising within fund asset type
GP financial backing
Fund sector focus
Fund geographically focused
Fund GP cash commitment
Fund management fee relative to peers
Fund preferred return relative to peers
Fund carried interest relative to peers
Fund direct alpha relative to peers
Fund KS-PME (Kaplan-Schoar public market equivalent) relative to peers
Prior fund direct alpha (public return component) relative to peers
Prior fund KS-PME relative to peers
Fund distributions concentration
Fund current distributions to paid-in (DPI) multiple relative to peers
Fund dry powder over time
Fund GP current carry
Prior fund quartile
Fund current quartile
Single asset concentration
   The drivers/signals listed above are exemplary, and others are contemplated to be within the scope of the present application. For example, with respect to buyout-type alternative assets, the drivers/signals may include, without limitation: purchase price multiples, leverage multiples, coverage ratios, trailing public market returns, rate of contribution, and/or fundraising percentage of public equity market capitalization, among others. Such and other drivers/signals are contemplated to be within the scope of the present application.

Based on the baseline multi-factor model described above and calibrating the private return component and public return component to historical data, the baseline multi-factor model can provide returns that match historical returns. The table below shows the “R\hat{ }2” statistics for a model fitting period of 2007-2020 and shows a “model error” of 0.0% for each approved type/class of Alternative Asset Product.

Private Fund Models - Historical Fit (2007-2020)

| | Alpha/Beta | R\hat{ }2 Model | Public | Fund | Model | Model |
|---|---|---|---|---|---|---|
| Private Fund Model | Fit | Fit | Factor | Return | Return | Error |
| Venture Capital | 4.6%/0.8 | 71% | 8.0% | 10.9% | 10.9% | 0.0% |
| Private Equity | 5.8%/0.7 | 79% | 8.4% | 12.1% | 12.1% | 0.0% |
| Private Debt | 1.2%/0.8 | 83% | 7.5% | 7.5% | 7.5% | 0.0% |
| Private Real Estate | 0.1%/0.9 | 67% | 7.3% | 6.6% | 6.6% | 0.0% |
| Natural Resources | 4.6%/0.6 | 71% | 3.1% | 6.5% | 6.5% | 0.0% |
| Infrastructure | 0.5%/1.7 | 38% | 2.6% | 4.9% | 4.9% | 0.0% |

As mentioned above, a “forward-adjusted” version of the multi-factor model adjusts the baseline version based on various forward-looking economic and market indicators to improve forecasts. The forward-adjusted multi-factor model adjusts the private return component and the public return components of the baseline model. In various embodiments, the forward-adjusted model can adjust the public return components based on macroeconomic forecasts (e.g., GDP growth, unemployment rate, inflation, etc.) and can adjust the private return component based on forecasts of the drivers/signals that are applicable to the type/class of Alternative Asset Products, such as the exemplary drivers/signals listed above.

As an example of forecasting a return, the baseline multi-factor model for a private equity class may be expressed as:

$$Return = α + {R}_{f} + β \times ( Public Market Return - {R}_{f} ) ,$$

where α denotes a private return component, β denotes the public market beta coefficient, “public market return” denotes the return of the public market index/indices associated to a private market, and R_{f} denotes short-term treasury rates (so-called “risk-free” rates).

The forward-adjusted multi-factor model adjusts the private return component and the public return component based on various forward-looking economic and market indicators to improve forecasts. Referring again to the baseline model for the private equity fund class, an example of the forward-adjusted multi-factor model may be expressed as:

$$Adjusted Return = Adjusted ( α ) + {R}_{f} + β ( Adjusted Market Return - {R}_{f} ) .$$

With continuing reference to FIG. 4, at block 430, the operation involves forecasting expected returns and, optionally, cashflow distributions for the Alternative Asset Product based on the corresponding multi-factor model. As mentioned above, the operation may be used solely to forecast expected returns and, optionally, distributions of an Alternative Asset Product, or may be used to forecast expected returns and, optionally, distributions of an Alternative Asset Product that is proposed as a Reference Asset for a new Financing, or may be used to forecast expected returns and, optionally, distributions of an Alternative Asset Product that is already a Reference Asset for an existing Financing, among other uses.

The forward-adjusted return can be used to forecast an expected return for an Alternative Asset Product based on economic conditions. As an example of bear-market economic conditions, the base forecast provided by the baseline model and the bear-market forecast provided by the forward-adjusted model may have the following exemplary values for various approved types/classes of Alternative Asset Products:

Private Market 5 Y Forecasts

| | Base Forecast | Bear Forecast |
|---|---|---|
| Private Equity | 8.1% | 6.1% |
| Venture Capital | 6.4% | 0.5% |
| Private Debt | 4.7% | 4.4% |
| Private Real Estate | 7.2% | −1.3% |
| Natural Resources | 10.6% | 7.8% |
| Infrastructure | 7.1% | 2.3% |

With continuing reference to block 430, the operation also forecasts cashflow distributions. The cashflow distributions can be forecasted using a stochastic model and simulation. In accordance with aspects of the present disclosure, the stochastic model captures the value the Alternative Asset Product over time. The value over time can be captured based on designating various phases of an Alternative Asset Product's lifecycle. FIG. 5 shows an exemplary lifecycle of a Fund which contains interests in alternative assets. As shown in the example of FIG. 5, the lifecycle phases include Investment Period phase, Portfolio Management phase, and Realization phase.

The phases of an Alternative Asset Product's lifecycle can inform the value of the Alternative Asset Product over time. Generally following formation, the first three to five years of a Fund are designated as the Investment Period. The Investment Period is the most active period in a Fund's lifecycle. During this period, the manager/general partner of the Fund is sourcing and evaluating potential investments of the Fund, conducting business and valuation due diligence, negotiating term sheets, and closing investment acquisitions. Each such acquisition closed by the manager/general partner generally reduces the Unfunded Capital Commitment of the Fund. In various embodiments, the “Unfunded Capital Commitment” refers to the amount of money an investor in a Fund is obligated to deliver to the manager/general partner of such fund upon a capital call by the manager/general partner of the Fund. After the Investment Period ends, some of the Unfunded Capital Commitment may still not be called. Additional Unfunded Capital Commitment may continue to be called to fund additional investments and/or for expenses, management fees, and similar expenses. After the Investment Period has expired, Unfunded Capital Commitment calls will generally lessen in frequency and amount. While the manager/general partner has discretion regarding investment decisions for the Fund, the timing and amounts of the holdings in the Fund may be relatively unpredictable due to broader market forces.

In view of the lifecycle dynamics described above, a cashflow projection model can model the interplay between the growing value of the alternative assets of the Fund, the capital calls that add new alternative assets to the Fund, and distribution of those assets from the Fund to investors. The cashflow projection model also models the behavior of the Unfunded Capital Commitment inside and outside the Investment Period. During the Investment Period, distributions from the Fund are assumed to be drawn as a positive fraction of the remaining net asset value (“NAV”) of the Fund in each time step, and the capital calls are taken to be a fraction of the remaining Unfunded Capital Commitment in each time step. Outside of the Investment Period, the Unfunded Capital Commitment is assumed to be written down by a positive rate that is large enough to deplete the remaining Unfunded Capital Commitment almost entirely after one year.

The dynamics NAV of the fund, or NAV of the individual alternative assets, is inferred from dynamics of similar types of assets in the public sector, either by directly regressing the reported NAVs of similar Funds on public factors, or by underwriting analysis, or some other treatment. In addition, the NAV of the Alternative Asset Product decreases at every distribution time by the amount of the distribution. Similarly, the NAV of the Fund increases at every capital call time by the amount of the capital call.

In accordance with aspects of the present disclosure, the cashflow projection model can implement a particular variation referred to herein as “Exponential Distribution Cashflow Model,” which combines statistical data from Fund databases and data derived from underwriting analysis. In the case of a Fund of interests in private companies, the Exponential Distribution Cashflow Model models the private companies owned by the Fund individually, and the NAV, capital calls, distributions, and Unfunded Capital Commitment of each private company are summed to give the total NAV, capital calls, distributions, and Unfunded Capital Commitment for the Fund.

The Exponential Distribution Cashflow Model uses capital call rates inferred statistically from private equity industry databases such as Preqin and uses NAV growth rates and volatilities inferred from models such as CAPM or the Fama-French Models, to infer the statistical properties of the NAV and capital call rates.

The distribution process for each private company owned by the Fund is defined from the expected distribution date derived by an underwriting analysis. The Exponential Distribution Cashflow Model treats this date as the mean of an exponential distribution, so that the Fund distribution process is a sum of exponential random variables. The Exponential Distribution Cashflow Model then adds in extra Boolean state variables to keep track of which assets have already made distributions. Thus, the Exponential Distribution Cashflow Model implements NAV processes for each private company in the Fund, the capital call rates, and the Boolean distribution variable, as random processes within the model.

The Exponential Distribution Cashflow Model is more computationally intensive when a Fund is near its inception. However, for older Funds with fewer private companies left in the Fund, the model is less computationally intensive while being more realistic than typical industry models which treat all company distributions together as a single continuous process. Additionally, the Boolean variables allow the Exponential Distribution Cashflow Model to age properly when a private company is sold earlier or later than expected.

Accordingly, the stochastic model and simulation described above permits the operation of block 430 to forecast cashflow distributions for an Alternative Asset Product, such as in connection with block 320 of FIG. 3.

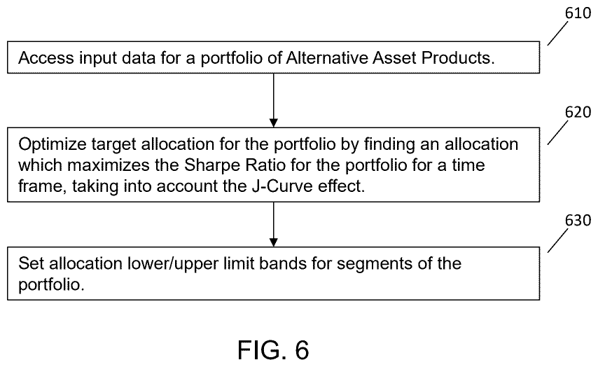

Referring now to FIG. 6, there is shown a block diagram of an exemplary operation for determining a target allocation for a portfolio of Alternative Asset Products. The operation of FIG. 6 can be implemented at block 330 of FIG. 3. A target allocation can include Alternative Asset Products of different approved alternate asset types/classes, of different regions, and/or of different sectors, among other things. The target allocation can be used to guide which risk dimensions of Alternative Asset Products should be targeted as new Reference Assets for new Financings, to structure the terms of a new Financing, and/or to monitor an existing portfolio of Alternative Asset Products, such as the portfolio 220 of FIG. 2.

The operation of FIG. 6 for determining a target allocation involves the Sharpe Ratio. As persons skilled in the art will understand, Sharpe Ratio indicates the average return earned in excess of the risk-free rate per unit of volatility of the return. A higher Sharpe Ratio indicates greater average return per unit of risk. In accordance with aspects of the present disclosure, the operation of FIG. 6 determines the target allocation by finding the optimal allocation of possible Alternative Asset Products of different risk dimensions (e.g., alternative asset types/classes, of different regions, and/or of different sectors, among other possibilities) which maximizes the Sharpe Ratio of the portfolio. The optimization process is subject to various business, financial, and/or investment requirements/constraints, such that the process finds a target allocation which satisfies all such requirements or constraints.

With continuing reference to FIG. 6, at block 610, the operation involves accessing input data for a portfolio of Alternative Asset Products. The input data can include, for example, risk and correlation forecasts, market return forecasts, investment/financials/business constraints or requirements, and a J-Curve parameter, which will be described in more detail below. The risk and correlation forecast data and the market return forecast data can be used to determine the Sharpe Ratio of the portfolio. The investment or financial or business constraints or requirements can be used to determined possible allocations of Alternative Asset Products which satisfy such constraints and requirements. For simplicity, the constraints or requirements may simply be referred to as “requirements.” The J-Curve parameter is used to compute the Sharpe Ratio, which is described below.

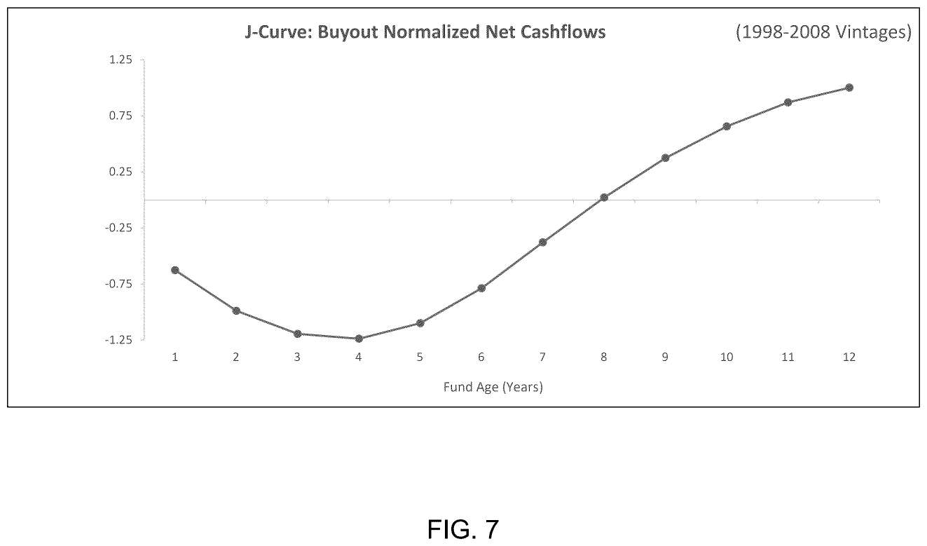

As mentioned above, a lifecycle of an Alternative Asset Product has various phases, as shown in FIG. 5. In accordance with aspects of the present disclosure, it has been determined that the highest performance Alternative Asset Products are generally those whose lifecycle is between the portfolio management and realization phase. Indeed, the particular risk vs. return characteristics of an Alternative Asset Product are correlated with the age of the Alternative Asset Product in the portfolio in the shape of a J-shaped curve, and such an effect is referred to herein as a J-Curve effect. An example of the J-Curve effect is shown in FIG. 7, in which normalized historical net cashflows for buyout Alternative Asset Products are plotted over the lifecycle of buyout Alternative Asset Products. As shown by FIG. 7, the normalized historical net cashflows form a J-shaped curve over the lifecycle of the funds, and the latter part of the lifecycle outperforms the earlier part of the lifecycle.

In accordance with aspects of the present disclosure. A J-Curve parameter, which takes into account the varying performance of an Alternative Asset Product over its lifecycle, is used to adjust the expected return of an Alternative Asset Product. The J-Curve parameter is incorporated via an internal rate of return adjustment for each Alternative Asset Product to account for the expected performance tilt for a given fund phase. Continuing with the example of FIG. 7, and starting with a predicted internal rate of return of a buyout fund over its entire lifecycle, the task for finding an optimal allocation for the first five years of the fund would involve adjusting the predicted internal rate of return down by approximately 40% to reflect the expected J-Curve effect. The J-Curve adjusted internal rate of return can then be used for the Sharpe Ratio to find a target allocation for the first five years of the fund. As an example, referring to the multi-factor model for the private equity fund class, described in connection with block 420 of FIG. 4, a Sharpe Ratio for the private equity fund class that incorporates the J-Curve parameter can be expressed by:

$$Sharpe Ratio = \frac{α + β \times ( Public Market Return - {R}_{f} ) - ( JCurve Parameter )}{{σ}_{f}}$$

$$where$$

$${σ}_{f} := Volatility Forecast ,$$

“JCurve Parameter” is the J-Curve parameter described above, and all other variables are the same as those described above in connection with block 420 of FIG. 4. A J-Curve parameter is applied to each Alternative Asset Product of a portfolio, and then the Sharpe Ratio for the portfolio as a whole is determined. The J-Curve example of FIG. 7 is exemplary, and a J-Curve effect for different types/classes of Alternative Asset Products will vary based on different periods and types of historical data. All such variations are contemplated to be within the scope of the present disclosure.

With continuing reference to FIG. 6, at block 620, the operation involves optimizing the allocation of Alternative Asset Products for the portfolio by finding an allocation which maximizes the Sharpe Ratio for the portfolio while satisfying the constraints and requirements, and while accounting for the J-Curve effect. In various embodiments, the operation may involve accessing a time frame for the portfolio, determining expected returns of the Alternative Asset Products for the portfolio, adjusting the expected returns of the Alternative Asset Products based on the risk-return characteristics of the J-curves corresponding to the time frame, and maximizing the Sharpe Ratio of the portfolio based on the adjusted expected returns of the Alternative Asset Products. The result of the operations at block 620 is the target allocation of Alternative Asset Products.

As persons skilled in the art will understand, it may be impractical to configure a portfolio to achieve the target allocation exactly. At block 630, the operation involves setting allocation lower and upper limit bands for segments of the portfolio to provide some leeway for the actual allocation to vary from the target allocation. In accordance with aspects of the present disclosure, allocation lower and upper limit bands are set for segments of the portfolio using risk-adjusted percentage bands below and above the target allocation for each portfolio segment. Each lower limit band and upper limit band has a range between the target allocation and, respectively, a lower limit and an upper limit, which can be expressed by:

$$Target Allocation ( TA ) = {Maximum}_{( h )} \{ ( Alt {ER}^{T} \times h - {r}_{f} - {δ}_{Tc} \times Tc ( h ) ) / \sqrt{{h}^{T} \times Alt \sum \times h} \} ,$$

$$where$$

$$h := allocation weights , {r}_{f} := risk free rate , Tc ( h ) := Transaction cost ,$$

$$Alt \sum = Alternative products expected covariance matrix$$

$$Alt ER := J Curve adjusted expected returns for alternative Product ,$$

$$and$$

$$Lower Limit := TA - ( Percentage ) \times Max ⌊ 0.5 , Min ⌊ 1.5 , ( {σ}_{seg} / {σ}_{port} ) ⌋ ⌋ ,$$

$$Upper Limit := TA + ( Percentage ) \times Max ⌊ 0.5 , Min ⌊ 1.5 , ( {σ}_{port} / {σ}_{seg} ) ⌋ ⌋ ,$$

$$where$$

$${σ}_{port} := volatility forecast of portfolio ,$$

$${σ}_{seg} := volatility forecast of segment ,$$

and “Percentage” is a predetermined percentage value. In various embodiments, the predetermined percentage value may be 5%. In various embodiments, the predetermined percentage value may be another percentage value. The equation above has the effect of producing lower limits for more volatile segments and slightly higher limits for less volatile segments. In various embodiments, the values 0.5 and 1.5 in the equation for lower/upper limit can be varied and can be other values depending on what is desired for a limit band.

Accordingly, the operations of FIG. 6 provide a target allocation of Alternative Asset Products and provide a lower limit band and an upper limit band for segments of the portfolio which allow the portfolio allocation to vary slightly from the target allocation. The operations shown in FIG. 6 are exemplary, and variations are contemplated to be within the scope of the present disclosure.

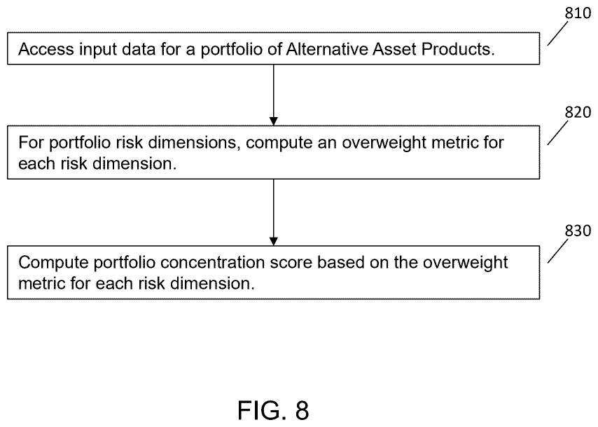

Referring now to FIG. 8, there is shown an exemplary operation for determining a portfolio concentration score for a portfolio of Alternative Asset Products. The operation of FIG. 8 can be implemented at block 340 of FIG. 3. In various embodiments, the operation of FIG. 8 can determine the level (e.g., in percentage terms) of portfolio over-allocation in any dimension of risk, such as Alternative Asset Product type/class, sector, geography, and/or specific fund or specific investment risks. In various embodiments, the operations can be used to evaluate the concentration of Alternative Asset Products in an existing portfolio. In various embodiments, the operations can be used to evaluate the concentration of Alternative Asset Products in a proposed portfolio or in a portfolio to which new Alternative Asset Products may be added.

In accordance with aspects of the present disclosure, the “portfolio concentration score” is calculated based on “risk dimensions” of the portfolio. The term “risk dimension” refers to an allocation dimension (e.g., region, section, etc.) which presents concentration risks when over-allocated. In various embodiments, the risk dimensions for computing the concentration score can be, for example, Alternative Asset Product type/class, sector, geography, specific fund risk, or specific investment risk. Each risk dimension may have sub-components. In various embodiments, the geography risk dimension is composed of both region concentration (e.g., Europe, Latin America, North America, etc.) and economic development concentration (e.g., emerging markets, developed markets). In various embodiments, the specific fund risk dimension refers to a single fund concentration. In various embodiments, the specific investment risk dimension refers to a particular investment, such as a portfolio company held by a fund. Such risk dimensions are exemplary, and other risk dimensions are contemplated to be within the scope of the present disclosure.

A risk dimension is “overweight” if its allocation is greater than the target allocation (or optionally greater than the upper limit band). An exemplary concentration score equation which is based on the five exemplary risk dimensions described above can be expressed, for example, by:

$$PORTFOLIO CONCENTRATION SCORE = 15 \% \times ( Asset Class overweight RSS ) + 15 \% \times ( Sector overweight RSS ) + 20 \% \times ( Geography overweight RSS ) + 20 \% \times ( Specific Fund overweight RSS ) + 30 \% \times ( Specific Investment overweight RSS )$$

Generally, the concentration score is a weighted sum of the overweight metrics for the risk dimensions. For a portfolio whose actual allocation matches the target allocation, no risk dimensions are overweight and the concentration score would be zero. For any risk dimension whose actual allocation matches the target allocation, the overweight metric for the risk dimension would be zero. The percentage weights/coefficients for the risk dimension are exemplary and, in the above example, are configured to emphasize highest risk to a portfolio from single investment concentration. Other percentage coefficient values different from the example above are contemplated to be within the scope of the present disclosure.

In the equation, “overweight RSS” refers to a root-of-sum-of-squares (RSS) metric. As mentioned above, each risk dimension may have sub-components. For example, the “asset class” risk dimension can have six sub-components: private equity, venture capital, private debt, private real estate, natural resource funds, and infrastructure funds. For this example with six sub-components, the Asset Class overweight root-of-sum-of-squares metric would be expressed

$$\sqrt{{\sum }_{i = 1}^{6} {Max ( 0 , {Allocation}_{i} - {Limit}_{i} )}^{2}} ,$$

as, for example, where Allocationᵢ is the actual allocation for sub-component i and Limitᵢ is the target allocation or the upper limit for sub-component i. In various embodiments, the value of Limitᵢ can be above the target allocation, such as the upper limit value described above herein. The RSS metric is exemplary, and in various embodiments, metrics other than RSS can be used for computing whether a risk dimension is overweight and for computing a concentration score.

With continued reference to FIG. 8, at block 810, the operation involves accessing input data for a portfolio of Alternative Asset Products. The input data can include, for example, the target allocation and the actual portfolio allocation values. At block 820, the operation involves computing an overweight metric for each risk dimension. The overweight metric may be the RSS metric described above. At block 830, the operation involves computing a portfolio concentration score based on the overweight metric for each risk dimension. The portfolio concentration score can use the equation described above or can use variations of the equation, such as different overweight metrics and/or different coefficient values. The portfolio concentration score can allow more accurate and active management of market exposures, which can help to decrease the risk of extreme losses during severe market corrections. As an example, the concentration score can be compared to a threshold value, and the portfolio may need to be reallocated if the concentration score exceeds the threshold value. The operation of FIG. 8 described above is exemplary, and variations are contemplated to be within the scope of the present disclosure.

Accordingly, described above are various operations for evaluating, diversifying, and/or monitoring Alternative Asset Products which serve as Reference Assets for Financings. Aspects of the operations can be applied to evaluating, diversifying, and/or monitoring Alternative Asset Products which are insured by an insurance policy. The following will describe an operation for providing a quote to persons or entities who may want to monetize their Alternative Asset Product, such as persons or entities 130 who hold Alternative Asset Products, as shown in FIG. 1.

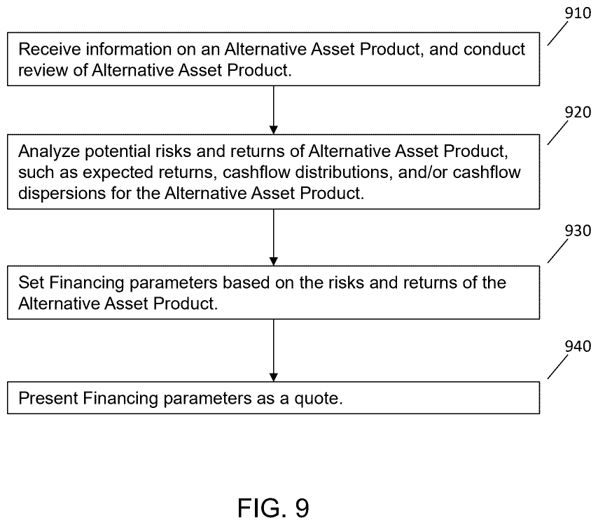

Referring now to FIG. 9, there is shown an exemplary operation for providing a quote relating to Alternative Asset Products. The operation of FIG. 9 can be implemented by a computing system, which will be described in connection with FIG. 10.

At block 910, the operation involves collecting information on an Alternative Asset Product. In various embodiments, the information may be received via an online portal, such as a webpage or an app. The information may be submitted by an entity which holds an Alternative Asset Product and which seeks to monetize the Alternative Asset Product, such as using the Alternative Asset Product as a Reference Asset for a Financing. Accordingly, the online portal may be a Financing application portal. Other embodiments are contemplated to be within the scope of the present disclosure. The received information may include, without limitation, a name of a Fund which holds interests in the alternative asset, a name of a general partner or managing firm which manages the Fund, an investment/commitment amount, and/or a most recently available net asset value (“NAV”) for the fund. The information described above are exemplary, and other information relating to an Alternative Asset Product may be received, such as, without limitation, a fund's annual audited financials, a fund's quarterly report to investors, and/or most recent schedule K-1 or 1099, among other things. All such other information are contemplated to be within the scope of the present disclosure.

With continuing reference to block 910, the operation involves conducting a review of the Alternative Asset Product based on the received information. The review can evaluate whether the Alternative Asset Product belongs to an approved alternative asset class. As mentioned above, in various embodiments, approved classes/types of Alternative Asset Products include one or more of the following: private equity, venture capital, leveraged buyout, structured credit, private debt, real estate, feeder funds, fund of funds, life insurance policies, natural resources, non-traded business development company, and/or non-traded real-estate investment trusts. Each approved class of alternative asset can be associated with minimum requirements as well as targeted or preferred characteristics specific to that class of alternative asset. As an example, a minimum requirement may be that the stated net asset value of the specific interest in the fund as reported by the fund manager must be greater than $50,000. As another example, a preferred characteristic may be, for a private equity fund, that at least 25% of committed capital of interest in the fund has been called by the fund manager and contributed by the fund investor. The review can determine whether the minimum requirements for the alternative asset class are satisfied and whether the Alternative Asset Product satisfies targeted or preferred characteristics. The review operations described above are exemplary, and other review operations are contemplated to be within the scope of the present disclosure.

At block 920, the operation involves analyzing potential risks and returns of Alternative Asset Product, such as expected returns, cashflow distributions, and/or cashflow dispersions of the Alternative Asset Product. In various embodiments, the expected return and the cashflow distributions of the Alternative Asset Product can be determined in the manner described in connection with FIG. 4, such as using a multi-factor model and/or using a stochastic model and simulation. In various embodiments, the expected return and cashflow distributions can be determined in another way. The cashflow dispersions can also be determined using the stochastic simulation and model described above. The stochastic model can identify the potential dispersion of the cashflows of similar assets in terms of both timing and value on the cashflow realizations.

At block 930, the operation involves setting Financing parameters based on the risks and returns of the Alternative Asset Product determined at block 920. The forecast of the cashflow dispersions may indicate range of cashflow outcomes of the Alternative Asset Product, which can be used to set Financing parameters. For example, a Financing level (or Financing-to-Value at the inception of a Financing) is the initial Financing balance which, when backed by the prospective Alternative Asset Product, implies a probability of Default that is equal to a certain pre-specified percentage. In determining Financing level, the operation of block 930 can assume a predetermined Financing structure, such as maturity date of a loan and interest rate, among other terms. The operation at block 930 can determine an initial Financing amount and expected return (e.g., loan interest rate), among other Financing parameters, in real-time, such as within seconds of receiving information in block 910.

Aspects of determining Financing level are described in co-pending U.S. Provisional Application No. 63/165,878, which is hereby incorporated by reference herein in its entirety. In particular, and with reference to FIG. 10, the operation determines the value of the Alternative Asset Product(s) and a risk adjusted rate of return specific to the Alternative Asset Product(s), and uses one or both of these metrics to ensure that the Alternative Asset Product(s) would provide sufficient cashflow/return or “Financing-to-value” to satisfy future returns (e.g., distributions, covering required returns, fees, and return of capital), under a range of a Reference Asset performance scenarios. In various embodiments, the operation can set certain parameters of a Financing having the Alternative Asset Product(s) as a Reference Asset, in order to meet desired credit ratings. In the case of a Reference Asset of more than one Alternative Asset Product, the Alternative Asset Products may encompass more than one alternative asset class.

Generally, the value of an Alternative Asset Product stems from future cashflows from the Alternative Asset Product or from pools of Alternative Asset Products. At block 1010, the operation involves projecting future cashflows to and from an Alternative Asset Product. In various embodiments, the projections can be performed using fundamental analysis. In various embodiments, the cashflow projections can be cross-referenced against historical data to determine how the cashflow projections based on fundamental analysis compare with historical cashflows for alternative assets with similar types of characteristics, such as alternative assets from similar geography, sector, vintage, and/or sub-asset class. Thus, the operation at block 1010 provides cashflow projections for an Alternative Asset Product.

At block 1020, the operation accesses a target Financing structure, which can include, among other things, target interest rates and fees. The target Financing structure can allow for cashflows from the Alternative Asset Product backing the Financing to be used to provide the returns on the Financing (e.g., distributions, covering required returns, fees, and return of capital). Other terms can be specified by the target Financing structure, and such terms are contemplated to be within the scope of the present disclosure.

At block 1030, the cashflow projections provided at block 1010 and the target Financing structure accessed at block 1020 can be used by a stochastic model to simulate potential future cashflows. The stochastic model takes into account the target Financing structure features (such as interest rate and fees, among others). In various embodiments, the stochastic model can take into account the structure of the Alternative Asset Product. In various embodiments, the stochastic model can take into account risk factors affecting the return profile of an Alternative Asset Product. In various embodiments, the stochastic model can compute the volatility of each Alternative Asset Product using forward looking risk models which leverage the volatilities and covariance information associated with a Reference Asset and key market factors, based on Alternative Asset Product characteristics such as the geography, sector, vintage, and/or sub-asset class. The stochastic model can also account for uncertainty related to cashflow timing and the dispersion across time of private cashflow realization, related to delayed monetization through sales or IPOs. Thus, block 1030 provides a range of potential future cashflows from the Alternative Asset Product.

In accordance with aspects of the present disclosure, the combination of Alternative Asset Product cashflows and target Financing structure inside the stochastic simulation at block 1030 results in a model which is stochastic in nature and which defines a joint probability distribution for the cashflows of the Alternative Asset Product at each time. From this joint probability distribution, probabilities of Default of a Financing backed by the Alternative Asset Product may be computed at block 1040. In various embodiments, the operation at block 1040 can take into account the mechanics of any cashflow waterfall. As mentioned above, the probability of Default refers to and includes the probability any occurrence or circumstance by which the specific agreed-upon expected return or specific agreed-upon insurance coverage is not satisfied according to the terms of the Financing.

At block 1050, the operation accesses one or more desired credit ratings for a Financing. As mentioned above, a Financing may have a credit rating on the OCC (Office of the Comptroller of the Currency) risk grading scale: 1-3 highest and above average, 4-9 satisfactory, 10-13 unsatisfactory, and 14 doubtful and loss. The operation may underwrite multiple Financing having different credit ratings. For example, the operation may underwrite certain Financing with a credit rating of A and may underwrite other Financing with a credit rating of B. The desired credit ratings may be based on a Credit Risk Loan Policy, among other things. Thus, one or more desired credit ratings is accessed at block 1050.

At block 1060, the operation involves determining a target Financing level based on a probability of Default determined at block 1040 and the desired credit rating(s) accessed at block 1050. As used herein, the target Financing level (or Financing-to-Value at the inception of a Financing) is the initial Financing balance which, when backed by the prospective Alternative Asset Product, implies a probability of Default that is equal to a certain pre-specified percentage, such as equal to the probability of Default corresponding to a desired credit rating.

The operation at block 1060 can determine the target Financing level by an iterative process. First, an initial bracket of Financing amounts is set to encompass the target Financing level. The upper bound of the initial bracket is a finite Financing amount which implies a probability of Default (determined at block 1040) that is greater than the probability of Default corresponding to the desired credit rating. The lower bound of the initial bracket is zero Financing amount. Thus, the initial bracket will contain the target Financing level somewhere in its range. In various embodiments, the probability of Default implied by the upper bound and the lower bound can be mapped to credit ratings, which would be above and below the desired credit rating.

Once the initial bracket is determined, initial bracket can be bisected and the midpoint of the bracket (i.e., the average of the upper and lower bound) can be evaluated to determine the implied probability of Default at the midpoint and/or the credit rating corresponding to the midpoint. If the implied probability of Default at the midpoint is higher than the probability of Default corresponding to the desired credit rating, or the credit rating at the midpoint is lower than the desired credit rating, then the midpoint becomes the new upper bound of the bracket. If the implied probability of Default at the midpoint is lower than the probability of Default corresponding to the desired credit rating, or the credit rating at the midpoint is higher than the desired credit rating, then the midpoint becomes the new lower bound of the bracket.

The bisection process then iterates until the implied probability of Default at the midpoint is exactly equal to or within a tolerance of the probability of Default corresponding to the desired credit rating, or the credit rating corresponding to midpoint is equal to or within a tolerance of the desired credit rating. At that point, the Financing amount value of the midpoint is used as the target Financing level. Because the probability of Default is a continuous and monotonic function of the Financing amount, the bisection process will arrive at the target Financing level, with the size of the bracket at each iteration being halved for the subsequent iteration. Thus, the operation of block 1060 can be used to determine a target Financing amount for a Financing backed by an Alternative Asset Product, to achieve a desired credit rating.

The operations shown in FIG. 10 are exemplary, and variations are contemplated to be within the scope of the present disclosure. In various embodiments, the process of determining a target Financing level may be different from the process described in connection with block 1060. Such and other variations are contemplated to be within the scope of the present disclosure.

Referring again to FIG. 9, at block 940, the operation involves presenting the Financing terms determined at block 930 as a quote to the entity which holds the Alternative Asset Products. The quote can be provided on the online portal where information was received in block 910. In various embodiments, the operation of blocks 930 and 940 can determine multiple packages of Financing terms, such as Financing with higher or lower interest rates and/or with higher or lower initial Financing amounts, among other parameters. In various embodiments, the entity using the online portal in block 910 can adjust various Financing parameters to desired values and receive a quote based on the desired parameter values. The operation of FIG. 9 is exemplary, and variations are contemplated to be within the scope of the present disclosure.

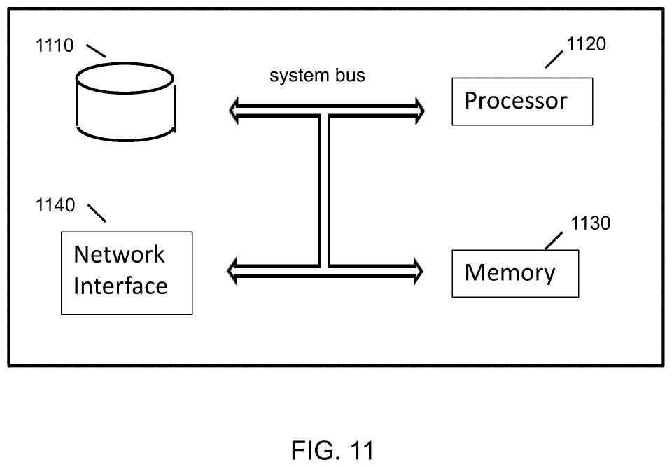

Accordingly, described above are various operations for evaluating, diversifying, and/or monitoring Alternative Asset Products which serve as Reference Assets for Financings, and/or for providing quotes. As mentioned above, the operations can be implemented by a computer system. FIG. 11 is a block diagram of an exemplary system for implementing the disclosed operations, in accordance with aspects of the present disclosure.

The system of FIG. 11 includes a database 1110, one or more processors 1120, at least one memory 1130, and a network interface 1140. In various embodiments, the computing system can be a proprietary server or can be a hosted server in the cloud. In embodiments, the computing system can be a single server or can include multiple servers in a single location or distribution across different locations.

The storage 1110 includes any device or material from which information may be accessed or reproduced, or held in an electromagnetic, optical, or other form for access by a computer processor. An electronic storage may be, for example, volatile memory such as RAM, non-volatile memory which permanently holds digital data until purposely erased (such as flash memory or solid state drives), magnetic devices such as hard disk drives, and/or optical media such as a CD, DVD, Blu-ray disc, among other storages.

In aspects of the present disclosure, the storage 1110 can store identity of an investor, trust documents for the various trusts, account information for the Financing, account information for the various trusts, and/or financial account information for deposit and transfer funds between the various entities, among other things. The data can be stored in the storage 1110 and sent via the system bus to the processor 1120. The system bus can be localized or network-based, and the storage need not co-reside with the processor and server memory, as long as all components are in communication with each other.

The processor 1120 executes instructions that can be stored in the memory 1130 and utilizes the data from the storage 1110. The instructions can execute the operations disclosed above herein. The computing system can communicate with other devices and servers through the network interface 1140. For example, the computing system can communicate with a third party server that stores account information.

In various embodiments, the computing system of FIG. 11 can include software applications that implement the transactions and operations described above herein. For example, various transactions may be transactions or portions of transactions can be implemented in a different sequence than as described or illustrated herein. Additionally, various transactions or portions of transaction can be implemented concurrently or simultaneously. Portions of one or more transactions can be implemented in one or more other transaction. In accordance with aspects of the present disclosure, a software application can be used to specify such different arrangements and timing of transactions or portions of transactions such that different investors can have different timing or different implementation of transactions. The software application can be used to arrange and rearrange the transactions with ease using, for example, a graphical user interface (not shown). Account information stored in the storage 1110 and the network interface 1140 can allow the pre-arranged transactions to be communicated with various entities and institutions.

In various embodiments, one or more software applications can implement an investor/client and advisor-credentialed site for the initiation of liquidity requests. Investors can provide details about Alternative Asset Products, upload asset documents, and track the progress of a transaction. They can also download a binding term sheet, when available, and request verification of accreditation.

In various embodiments, one or more software applications can implement an underwriting and risk application for documenting valuation, pricing, and ultimate offering terms. The application can incorporate a controlled sequence of tasks to ensure all parties complete their assigned responsibilities. The application can include manager approvals throughout the transaction and can provide the ability to manage multiple portfolios and offering scenarios within a single transaction, as well as selection of final deal terms to feed into other applications or systems.

In various embodiments, one or more software applications can implement an account and transaction management application, which can be used by originations, legal, and investment operations teams. The originations team can use the application to create new accounts for investors and advisors. The legal team can use the application to review investor-provided information for purposes of anti-money laundering or other efforts. The legal team can also use the application to provide deal terms required for the generation of trust and other documents. The investment operations team can use the application to compile and distribute transaction documents, including the binding term sheet and various plan documentation.

In various embodiments, one or more software applications can implement automated generation of Financing documents (e.g., Financing documents, special purpose vehicle documents) using data provided by one or more other application described above, can implement distribution of trust documents to appropriate parties, and can implement creation and review of accounting journal entries. Various other functionalities can be implemented.

The embodiment of FIG. 11 is exemplary, and variations are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A computer-implemented method comprising:
accessing information relating to an Alternative Asset Product received through an online portal;
computing an expected return for the Alternative Asset Product;
forecasting cashflow dispersion for the Alternative Asset Product based on a quantitative stochastic model and simulation;
determining Financing parameters for a proposed Financing based on the expected return and the forecasted cashflow dispersion for the Alternative Asset Product and based on the Alternative Asset Product serving as a Reference Asset for the proposed Financing; and
presenting the Financing parameters through the online portal as a real-time quote.

2. The computer-implemented method of claim 1, wherein the Financing parameters are determined based on a predetermined Financing structure.

3. The computer-implemented method of claim 1, further comprising receiving a desired Financing structure via the online portal, wherein the Financing parameters are determined based on the desired Financing structure.

4. The computer-implemented method of claim 1, wherein the Financing parameters include a Financing level based on the Alternative Asset Product serving as a Reference Asset for the proposed Financing and based on a predetermined Default rate.

5. A system comprising:
one or more processors; and
at least one memory storing instructions which, when executed by the one or more processors, cause the system to:
access information relating to an Alternative Asset Product received through an online portal;
compute an expected return for the Alternative Asset Product;
forecast cashflow dispersion for the Alternative Asset Product based on a quantitative stochastic model and simulation;
determine Financing parameters for a proposed Financing based on the expected return and the forecasted cashflow dispersion for the Alternative Asset Product and based on the Alternative Asset Product serving as a Reference Asset for the proposed Financing; and
present the Financing parameters through the online portal as a real-time quote.

6. The system of claim 5, wherein the Financing parameters are determined based on a predetermined Financing structure.

7. The system of claim 5, wherein the instructions, when executed by the one or more processors, further cause the system to receive a desired Financing structure via the online portal,
wherein the Financing parameters are determined based on the desired Financing structure.

8. The system of claim 5, wherein the Financing parameters include a Financing level based on the Alternative Asset Product serving as a Reference Asset for the proposed Financing and based on a predetermined Default rate.
